(19) United States
(12) Patent Application Publication
(10) Pub. No.: US 2019/0042415 A1
(43) Pub. Date: Feb. 7, 2019

(54) STORAGE MODEL FOR A COMPUTER SYSTEM HAVING PERSISTENT SYSTEM MEMORY

(71) Applicant: Intel Corporation, Santa Clara, CA (US)

(72) Inventors: James A. BOYD, Hillsboro, OR (US); Dale J. JUENEMANN, North Plains, OR (US)

(21) Appl. No.: 16/006,484

(22) Filed: Jun. 12, 2018

(51) Int. Cl. G06F 12/0804; G06F 12/1045; G06F 9/30

(52) U.S. Cl. CPC G06F 12/0804; G06F 12/1045; G06F 2212/657; G06F 2212/1032; G06F 2212/1024; G06F 9/3012

(57) ABSTRACT

A processor is described. The processor includes register space to accept input parameters of a software command to move a data item out of computer system storage and into persistent system memory. The input parameters include an identifier of a software process that desires access to the data item in the persistent system memory and a virtual address of the data item referred to by the software process.

### FIELD OF INVENTION

The field of invention pertains generally to computer system design, and, more specifically, to an improved storage model for a computer system having persistent system memory.

### BACKGROUND

Computer system designers are highly motivated to increase the performance of the computers they design. Computers have traditionally included system memory and non volatile mass storage that were essentially separate and isolated hardware components of the system. However recent advances in non-volatile memory technology and system architecture have permitted system memory to begin to take on system roles that were traditionally handled by non volatile mass storage.

### FIGURES

A better understanding of the present invention can be obtained from the following detailed description in conjunction with the following drawings, in which:

FIG. 1 shows a two-level system memory;

FIGS. 2a and 2b show two storage models that can be used with a system having persistent system memory;

FIG. 3 shows an improved storage model that can be used with a system having persistent system memory;

FIG. 4 shows a method for emulating DAX mode on system having persistent system memory that implements a traditional file system storage model;

FIG. 5 shows a computing system that can be used to implement the improved storage model of FIG. 3.

### DETAILED DESCRIPTION

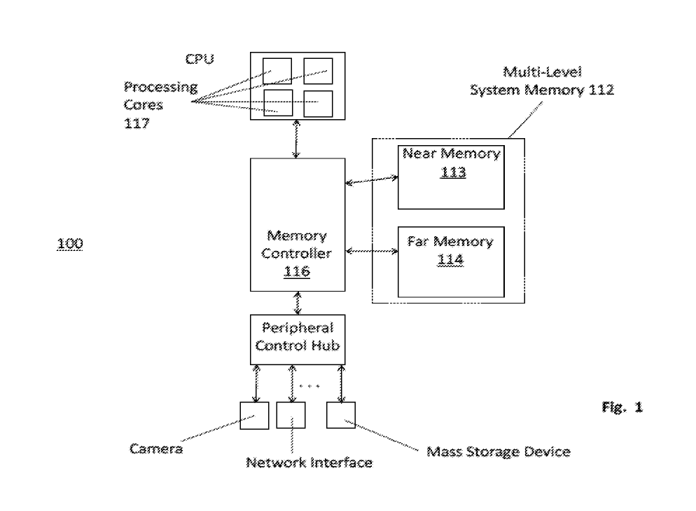

FIG. 1 shows an embodiment of a computing system 100 having a multi-tiered or multi-level system memory 112. According to various embodiments, a smaller, faster near memory 113 may be utilized as a cache for a larger, slower far memory 114. In various embodiments, near memory 113 is used to store the more frequently accessed items of program code and/or data that are kept in system memory 112. By storing the more frequently used items in near memory 113, the system memory 112 will be observed as faster because the system will often read/write from/to items that are being stored in faster near memory 113.

According to various embodiments, near memory 113 has lower access times than the lower tiered far memory 114 For example, the near memory 113 may exhibit reduced access times by having a faster clock speed than the far memory 114. Here, the near memory 113 may be a faster (e.g., lower access time), volatile system memory technology (e.g., high performance dynamic random access memory (DRAM) and/or SRAM memory cells) co-located with the memory controller 116. By contrast, far memory 114 may be a non volatile memory technology that is slower (e.g., longer access time) than volatile/DRAM memory or whatever technology is used for near memory.

For example, far memory 114 may be comprised of an emerging non volatile random access memory technology such as, to name a few possibilities, a phase change based memory, a three dimensional crosspoint memory, “write-in-place” non volatile main memory devices, memory devices having storage cells composed of chalcogenide, multiple level flash memory, multi-threshold level flash memory, a ferro-electric based memory (e.g., FRAM), a magnetic based memory (e.g., MRAM), a spin transfer torque based memory (e.g., STT-RAM), a resistor based memory (e.g., ReRAM), a Memristor based memory, universal memory, Ge2Sb2Te5 memory, programmable metallization cell memory, amorphous cell memory, Ovshinsky memory, etc. Any of these technologies may be byte addressable so as to be implemented as a system memory in a computing system (also referred to as a “main memory”) rather than traditional block or sector based non volatile mass storage.

Emerging non volatile random access memory technologies typically have some combination of the following: 1) higher storage densities than DRAM (e.g., by being constructed in three-dimensional (3D) circuit structures (e.g., a crosspoint 3D circuit structure)); 2) lower power consumption densities than DRAM when idle (e.g., because they do not need refreshing); and/or, 3) access latency that is slower than DRAM yet still faster than traditional non-volatile memory technologies such as FLASH. The latter characteristic in particular permits various emerging non volatile memory technologies to be used in a main system memory role rather than a traditional mass storage role (which is the traditional architectural location of non volatile storage).

In various embodiments far memory 114 acts as a true system memory in that it supports finer grained data accesses (e.g., cache lines) rather than only larger based “block” or “sector” accesses associated with traditional, non volatile mass storage (e.g., solid state drive (SSD), hard disk drive (HDD)), and/or, otherwise acts as a byte addressable memory that the program code being executed by processor(s) of the CPU operate out of.

In various embodiments, system memory may be implemented with dual in-line memory module (DIMM) cards where a single DIMM card has both volatile (e.g., DRAM) and (e.g., emerging) non volatile memory semiconductor chips disposed on it. In other configurations DIMM cards having only DRAM chips may be plugged into a same system memory channel (e.g., a double data rate (DDR) channel) with DIMM cards having only non volatile system memory chips.

In another possible configuration, a memory device such as a DRAM device functioning as near memory 113 may be assembled together with the memory controller 116 and processing cores 117 onto a single semiconductor device (e.g., as embedded DRAM) or within a same semiconductor package (e.g., stacked on a system-on-chip that contains, e.g., the CPU, memory controller, peripheral control hub, etc.). Far memory 114 may be formed by other devices, such as an emerging non-volatile memory and may be attached to, or integrated in the same package as well. Alternatively, far memory may be external to a package that contains the CPU cores and near memory devices. A far memory controller may also exist between the main memory controller and far memory devices. The far memory controller may be integrated within a same semiconductor chip package as CPU cores and a main memory controller, or, may be located outside such a package (e.g., by being integrated on a DIMM card having far memory devices).

In various embodiments, at least some portion of near memory 113 has its own system address space apart from the system addresses that have been assigned to far memory 114 locations. In this case, the portion of near memory 113 that has been allocated its own system memory address space acts, e.g., as a higher priority level of system memory (because it is faster than far memory). In further embodiments, some other portion of near memory 113 may also act as a memory side cache (that caches the most frequently accessed items from main memory (which may service more than just the CPU core(s) such as a GPU, peripheral, network interface, mass storage devices, etc.) or last level CPU cache (which only services CPU core(s)).

Because far memory 113 is non volatile, it can also be referred to as “persistent memory”, “persistent system memory” and the like because its non-volatile nature means that its data will “persist” (not be lost) even if power is removed.

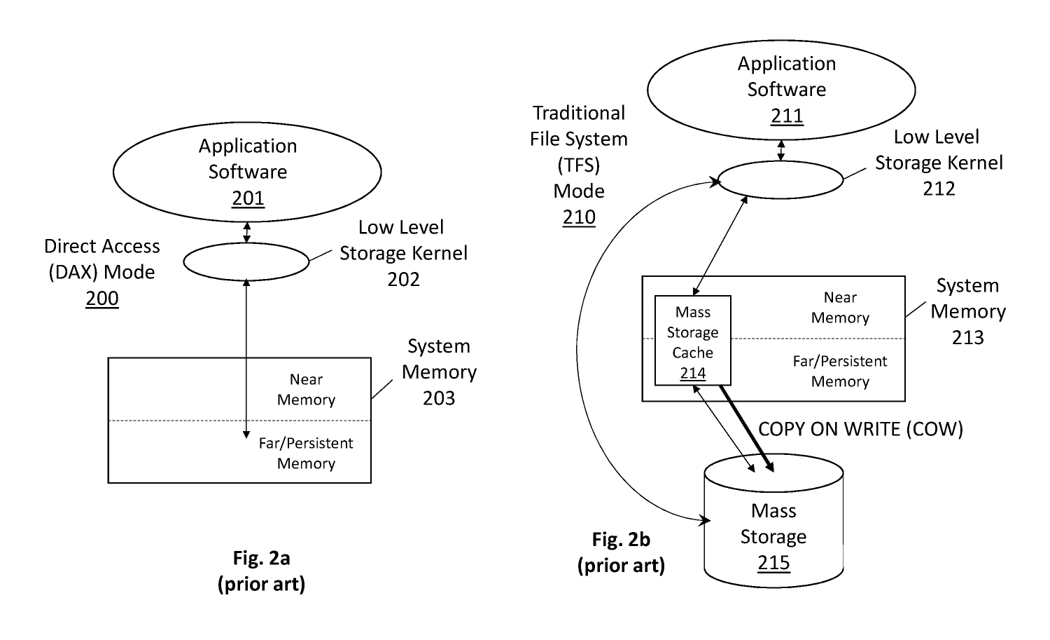

FIGS. 2a and 2b respectively show two system storage models 200, 210 that can be used in a system having persistent system memory resources. According to the first model 200 of FIG. 2a, referred to as direct access (DAX) mode, application software 201 (e.g., storage application software) reaches data items that have been stored in non volatile persistent memory through a low level storage kernel 202. The low level storage kernel 202 may be one or more low level components of software such as one or more components of an operating system (OS) kernel, virtual machine monitor (VMM) and/or mass storage hardware device driver that form a software platform “beneath” the application software 201. The low level storage kernel 202 is able to perform, e.g., byte addressable load/store operations directly out of non-volatile (persistent) memory resources of system memory 203.

Traditional computing systems have permitted storage applications or other software processes that required “commitment” (or other forms of a non volatile guarantee that data would not be lost) to operate out of volatile, DRAM system memory. However, in order to ensure that data would not be lost as a consequence of the volatile nature of DRAM, any store (write) operation into DRAM system memory was automatically followed by a “copy” write of the data to deeper, non-volatile mass storage (e.g., hard disk drive (HDD), solid state drive/device (SSD), etc.). As such, any improvement in performance obtained by permitting such software to operate out of DRAM system memory was somewhat counter balanced by the additional internal traffic generated from the copy operation (also referred to as a “copy-on-write” operation).

The DAX model 200 does not include any copy operation to deeper mass storage because the model understands the data is being written to persistent memory and therefore does not need to be automatically backed up. As a consequence, the DAX model 200 represents an ideal mode of operation from the perspective of guaranteeing that data will not be lost while, at the same time, minimizing internal traffic within the computing system.

Notably, therefore, if the storage capacity of the persistent memory is sufficient to meet the non-volatile storage needs of the entire computing system (which requires, e.g., storage of all operating system software program code, storage of all application software program code and associated data, etc.), then the computing system conceivably does not need any traditional mass storage devices. That is, the persistent memory, although formally being a component of system memory, obviates the need for deeper non-volatile mass storage because of is non-volatile nature.

Unfortunately some systems, such as lesser performance client devices (e.g., desktop computers, laptop computers, battery operated handheld devices (e.g., smartphones), smart appliances (internet-of-things (loT) devices), etc.) may not include enough persistent memory to completely obviate the need for deeper mass storage. Such systems will therefore include one or more deeper mass storage devices so that the complete set of system software and other critical information can be permanently kept by the system even when power is removed.

Unfortunately, as a consequence of such systems being forced to include deeper mass storage device(s), they are also forced to rely on a traditional file system (TFS) model alluded to above. That is, storage software or other software processes that need to guarantee their data will not be lost may be free to write data to a mass storage cache 214 in system memory 213 (which may include writing to, e.g., a volatile DRAM near memory level and/or a non volatile persistent memory level).

However, such data that is written to the mass storage cache 214 will automatically be written back to mass storage 215 through a copy-on-write operation—even if such data is written to persistent system memory resources. Here, irrespective of whether data is written to a DRAM level of system memory or a non volatile level of system memory, system memory 213 as a whole is viewed as a cache 214 for mass storage 215 whose state needs to be committed back to mass storage to guarantee safe keeping of data and/or consistency of data within the system. As such, the efficiency advantage of the DAX model (elimination of internal copy traffic) is lost when the TFS model 210 is imposed on a computer system having non volatile system memory.

A new model that does not offend the implementation of the traditional copy-on-write model within the system yet obviates the copy-on-write operation when software writes to non volatile system memory resources would be beneficial because the efficiency advantage of the DAX model could effectively be realized within the system even though the system does not formally implement the DAX model.

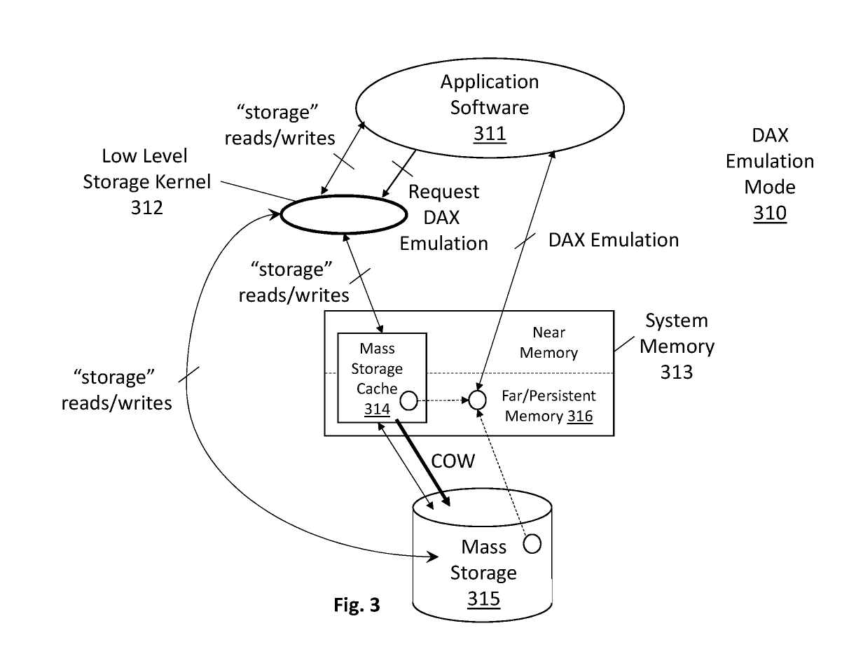

FIG. 3 depicts an embodiment of such a model 300 (which herein is referred to as “DAX emulation” model). As observed in FIG. 3, the system is presumed to include a multi-level system memory in which some portion of the volatile DRAM level and/or the non volatile persistent/far memory level is utilized as a mass storage cache 314. When application data is written to the mass storage cache 314, the data is formally written back to mass storage 315 as a copy-on-write operation. As such, the traditional file system is formally recognized and operationally exists within the computer.

In various embodiments, application software 311 (such as a storage application) may understand/recognize when it is writing to the “mass storage” 315 (or simply, “storage” 315) of the system. The lower level storage kernel 312 may effect or otherwise be configured to implement a mass storage cache 314 in system memory 313, by, e.g., directing “storage” writes from the application software 311 to the mass storage cache 314 that resides in system memory followed by a copy-on-write operation of the write data to mass storage 315. As such, “storage” writes are formally performed by the system according to the TFS model.

However, in the improved model 300 of FIG. 3, application software 311 is smart enough to understand that persistent system memory resources exist in the system and therefore, may request that data that is stored in the system's mass storage (e.g., a data file) be mapped in system memory address space of the persistent system memory. Here, for instance, whereas mass storage region 314 of corresponds to a region of system memory that is configured to behave as a mass storage cache (and may include either or both levels of a multi-level system memory) and whose contents must therefore be copied back to mass storage, by contrast, region 316 corresponds to actual system memory having allocable system memory address space.

With the application software 311 being smart enough to recognize the existence of non volatile system memory 316 within the system, the application software 311 formally issues a request to the storage system, e.g., via the low level storage kernel 313, to “release” a file or other data item within mass storage 314, 315 and enter it into a persistent region of system memory 316. According to one approach, if the latest version of the data item already exists in the mass storage cache 314 the data item is physically moved from mass storage cache region 314 to the persistent system memory region. Alternatively, if the latest version of the data item already exists in non volatile resources of the mass storage cache 314 (e.g., resides within a persistent memory portion of the mass storage cache 314), its current address in the persistent memory is swapped from being associated with the mass storage cache 314 to being associated with system memory. If the data item does not exist in the mass storage cache 314 it is called up from mass storage 315 and entered into a region of persistent system memory 316.

Regardless, after the storage system fully processes the request, the data item resides in a non volatile region of system memory 316 rather than the system's “storage” subsystem (although a duplicate copy may be kept in storage for safety reasons). When the application 311 subsequently writes to the data item it understands that it is not writing to “storage”, but rather, that it is writing to “system memory” in DAX emulation mode. As alluded to above, the application 311 may be smart enough to understand that the region 316 of system memory being written to is non volatile and therefore the safety of the data is guaranteed. Importantly, because the write data is written to a non volatile region 316 of system memory (and not “storage”), no copy-on-write operation to mass storage is required or performed in response to write operations performed on the data item in the non volatile region 316 of system memory. As such, after processing the request, the system is effectively emulating DAX operation even though the DAX model is not formally recognized within the system.

The semantic described above may be particularly useful, e.g., if the application software 311 recognizes or otherwise predicts that it will imminently be updating (or better yet, imminently and frequently updating) a particular data item. The application therefore requests the mass storage system to release the data item and map it to persistent system memory 316. The application 311 may then proceed to perform many frequent updates to the data item in persistent system memory 316. With no copy-on-write being performed, the inefficiency of copying each write operation back to mass storage 315 is avoided thereby improving the overall efficiency of the system. After the application 311 believes/predicts its updating to the data item is finished, e.g., for the time being, it may write the data item to “storage” so that, e.g., the space consumed by the data item in persistent system memory 316 can be used for another data item from storage.

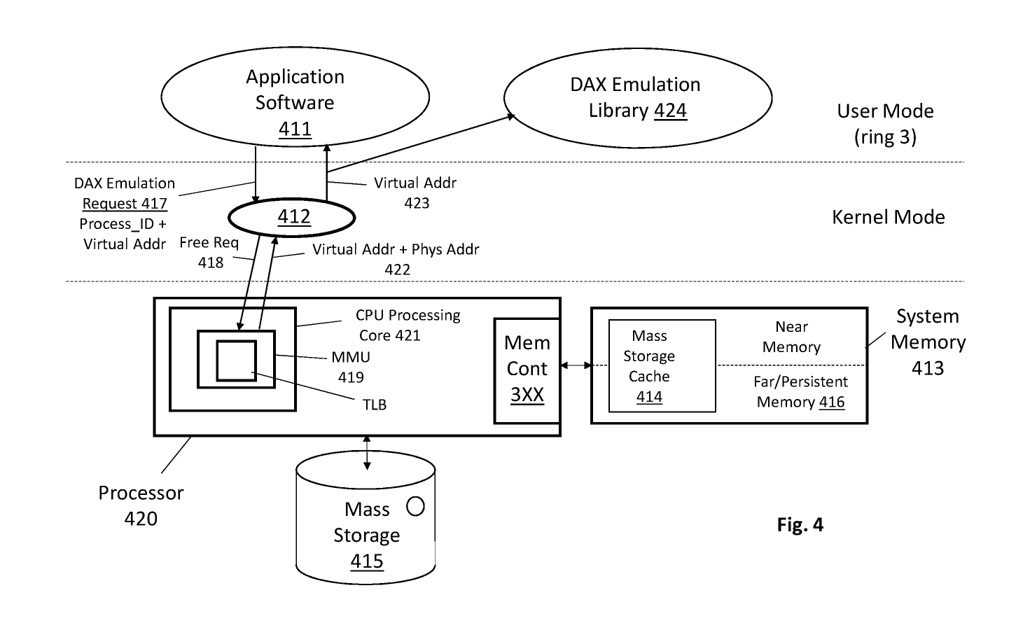

FIG. 4 shows a more detailed embodiment of a methodology by which an application requests system storage to release an item of data and then map the data item into persistent system memory.

As is known in the art, a software application is typically allocated one or more software “threads” (also referred to as “processes”) that execute on central processing unit (CPU) hardware resources. Moreover, software applications and the threads used to execute them are typically allocated some amount of system memory address space. The application's actual program code calls out “virtual” system memory addresses when invoking system memory for program code reads or data reads and data writes. For instance, the program code of all applications on the computer system may refer to a system memory address range that starts at address 000 . . . 0. The value of each next memory address referred to by the application increments by +1 until an address value that corresponds to the final amount of system memory address space needed by the application is reached (as such, the amount of system memory address space needed by the application corresponds to its virtual address range).

The computer, however, e.g., through the processor hardware and the operating system that the application operates on (and/or a virtual machine monitor that the operating system operates on) dynamically allocates physical system memory address space to the applications that are actively executing. The dynamic allocation process includes configuring the processor hardware (typically, a translation look-aside buffer (TLB) within a memory management unit (MMU) of the CPU) to translate a virtual address called out by a particular application to a particular physical address in system memory. Typically, the translation operation includes adding an offset value to the application's virtual address.

As described in more detail below, an application is typically written to refer to “pages” of information within system memory. A page of information typically corresponds to a small contiguous range of virtual addresses referred to by the application. Each page of information that can be physically allocated in system memory for an application typically has its own unique entry in the TLB with corresponding offset. By so doing, the entire system memory address space that is allocated to the application need not be contiguous. Rather, the pages of information can be scattered through the system memory address space.

The TLB/MMU is therefore configured by the OS/VMM to correlate a specific thread/process (which identifies the application) and virtual address called out by the thread/process to a specific offset value that is to be added to the virtual address. That is, when a particular application executes a system memory access instruction that specifies a particular virtual memory address, the TLB uses the ID of the thread that is executing the application and the virtual address as a lookup parameter to obtain the correct offset value. The MMU then adds the offset to the virtual address to determine the correct physical address and issues a request to system memory with the correct physical address.

As observed in FIG. 4, the DAX emulation process includes an application 411 initially requesting 417 its mass storage kernel 412 to release a data item from the storage system and enter it into non volatile resources 416 of system memory 413. Here, as is understood in the art, when an application accesses the storage sub-system, it makes a function call to its mass storage kernel 412. In the DAX emulation process of FIG. 4, the application sends a “release request” for a specific data item (e.g., identified by its virtual address) to the mass storage kernel 412. Associated with the request is the ID of the thread that is executing the application 411. The thread ID may be passed as a variable through the kernel's application programming interface (API) or may be obtained by the kernel 412 via some other background mechanism (such as the application registering its thread ID with the kernel 412 when the application is first booted).

With the thread ID and virtual address of the specific data item known to the mass storage kernel 412, the mass storage kernel 412 begins the process of moving the data item formally out of the storage system and into persistent system memory 416. As observed in FIG. 4, in an embodiment, the kernel 412 requests 418 a “free” (unused) persistent system memory address from the processor MMU 419 or other hardware of the processor 420 that has insight into which persistent system memory addresses are not presently allocated.

Part of the request 418 for a free system memory address includes passing the thread ID to the MMU 419. The MMU 419 determines a physical address within the persistent system memory 416 that can be allocated to the data item and also determines a corresponding virtual address that is to be used when referring to the data item. The MMU 419 is then able to build an entry for its TLB that has both the virtual address that is to be used when referring to the data item and the thread ID that will be attempting to access it (which corresponds to the application 411 that has made the request). The entry is entered into the TLB to “setup” the appropriate virtual to physical address translation within the CPU hardware 421.

The MMU 419 then returns 422 to the mass storage kernel 412 both the newly identified virtual address that is to be used when attempting to access the data item and the physical address in persistent system memory 416 where the data item is to be moved to. With knowledge of the system memory physical address that the data item is to be moved to, the mass storage kernel 412 then acts to move the data item to that location.

Here, if the data item is in the mass storage device 415, the mass storage kernel 412 calls up the data item from mass storage 415 and enters it into the persistent memory 416 at the physical address returned by the MMU 419.

By contrast, if the data item is in the mass storage cache 414, in one embodiment, the mass storage kernel 412 reads the data item from the mass storage cache 414 and writes it into persistent system memory 316 at the newly allocated physically address. In an alternate embodiment, the system memory addresses that are allocated to the mass storage cache 414 need not be contiguous. Here, system memory addresses that are allocated to the mass storage cache 414 are dynamically configured/reconfigured and can therefore be scattered throughout the address space of the system memory 413. If the mass storage cache 414 is implemented in this manner and if the data item of interest currently resides in a persist memory section of mass storage cache 414, rather than physically moving the data item to a new location, instead, the mass storage kernel 412 requests the MMU 419 to add a special TLB entry that will translate the virtual address for accessing the data item to the persistent memory address where the data item currently resides in the mass storage cache 314.

The MMU 419 determines the virtual address that is to be used for referring to the data item and with the thread ID provided by the mass storage kernel 412 is able to build the TLB entry so that its translations will map to the current location of the data item. The virtual address that is to be used when referring to the data item is then passed 422 to the mass storage kernel 412. When the TLB entry is formally added and takes effect and the mass storage kernel 412 is likewise able to recognize the loss of its mass storage cache address (e.g., by updating a table that lists the system memory addresses that correspond to the mass storage cache), the location in persistent memory where the data item currently resides will formally be converted from a mass storage cache location to persistent system memory location. As such, the removal of the data item from the storage system and its entry into persistent system memory is accomplished without physically moving the data item within the persistent memory (it remains in the same place).

Note that the “data item” may actually correspond to one or more pages of information. Here, as is known in the art, the TFS model includes the characteristic that, whereas system memory is physically accessed at a fine degree of data granularity (e.g., cache line granularity), by contrast, mass storage is accessed at a coarse degree of data granularity (e.g., multiple cache lines worth of information that correspond to one or more “pages” of information). As such, information is generally moved from mass storage 415 to system memory 413 by reading one or more pages of information from mass storage 415 and writing the one or more pages of information into system memory 413.

In various embodiments, the “data item” that the application requests to be removed from the storage system and entered into persistent system memory corresponds to the address of one or more pages of information where each page contains multiple cache lines of data. Presumably, the application 411 seeks DAX emulation for at least one of these cache lines. As such, “release” of the data item from the storage system to persistent system memory actually entails the release of one or more pages of data rather than only one cache line worth of information.

Furthermore, note that according to traditional operation, the MMU 419 or other processor hardware is responsible for recognizing when a virtual address called out by an application does not correspond to a page of information that currently resides in system memory 413. In response to such recognition, the MMU 419 will call up from mass storage 415 the page of information having the targeted data and write it into system memory 413. After the page of information has been written into system memory 413, the memory access request can be completed. The swapping in of the page of information from mass storage 415 may be at the expense of the swapping out of another page of the application's information from system memory 413 back to mass storage 415. Such behavior is common for applications that are allocated less physical memory space in system memory 413 than the total amount of pages of information that they are written to refer to.

Irrespective of which approach is taken for removing the data item from the storage system and entering it into persistent system memory (call up data item from mass storage, physically move data item from mass storage cache to persistent system memory, or re-characterize the data item's location in persistent memory from mass storage cache to persistent system memory), the mass storage kernel 412 ultimately understands when the data item is formally outside the mass storage system, when the data item is formally within persistent system memory 416 and has been informed of the appropriate virtual address to use when referring to the data item in persistent system memory 416. At this point, the mass storage kernel 412 completes the request process by providing 423 the new virtual address to the application 411. Going forward, the application 411 will use this virtual address when attempting to access the data item directly from persistent system memory 416. With the TLB entry having already been entered in the MMU 419, the CPU hardware 421 will correctly determine the physical location of the data item in system memory 416.

In a further embodiment, an application software level “library” 424 exists that essentially keeps track of which data items are presently in persistent system memory 416 for emulated DAX access. Here, for instance, a same data item may be used by multiple different applications and the library 424 acts as a shared/centralized repository that permits more than one application to understand which data items are available for DAX emulation access.

For example, when an application requests that a data item be formally removed from the storage system and entered in persistent system memory for DAX emulation, upon the completion of the request, the special virtual address to be used for accessing the data item that is returned 423 by the mass storage kernel 412 is entered in the library 424 (along with, e.g., some identifier of the data item that is used by the application(s)). Subsequently, should another application desire access to the data item, the application can first inquire into the library 424. In response the library 424 will confirm DAX emulation is available for the data item and provide the other application with the virtual address that is to be used for accessing the data item.

Likewise, when an application desires to remove a data item from persistent system memory 416, it may first notify the library 424 which keeps a record of all applications that have inquired about the same data item and have been provided with its DAX emulation virtual address. The library 424 may then ping each such application to confirm their acceptance of the data item being removed from persistent system memory 416. If all agree (or if at least a majority or quorum agree), the library 424 (or the application that requested its removal) may request that the data item be removed from persistent system memory and entered back into the mass storage system (also, note that the library 424 may act as the central function for requesting 417 DAX emulation for a particular data item rather than an application 411).

Entry of the data item back into the storage system from persistent system memory 416 may be accomplished by any of: 1) physically writing the data item back into mass storage 415; 2) physically writing the data item back into the mass storage cache 414; or, 3) re-characterizing the location where the data item resides as being part of mass storage cache 414 rather than persistent system memory 416. Regardless, the special entry that was created in the TLB for the DAX emulation access to the data item is shot down from the TLB so that the virtual-to-physical address translation that was configured for the data item in DAX emulation mode can no longer transpire. After the TLB shoot down and migration of the data item back to storage is complete, the requesting application/library is informed of its completion and the active library record for the data item and its virtual address is erased or otherwise deactivated.

The processor hardware 420 may be implemented with special features to support the above described environment and model. For example, the processor may include model specific register space, or other form of register space, and associated logic circuitry, to enable communication between the mass storage driver 412 and the processor 420 for implementing the above described environment/model. For instance, the processor may include special register space into which the mass storage drive writes the process_ID and/or virtual address associated with the request 418 to move a data item into persistent system memory 416. Logic circuitry associated with the register space may be coupled to the MMU or other processor hardware to help exercise the request response semantic(s).

Moreover, register space may exist through which the processor hardware returns the new virtual address to use with the data item. The MMU or other processor hardware may also include special hardware to determine the new virtual address in response to the request. The memory controller may include special logic circuitry to read a data item (e.g., page of information) from one region of system memory (e.g., one region of persistent memory) and write it back into the persistent memory region where the data item is to be accessed in DAX emulation mode.

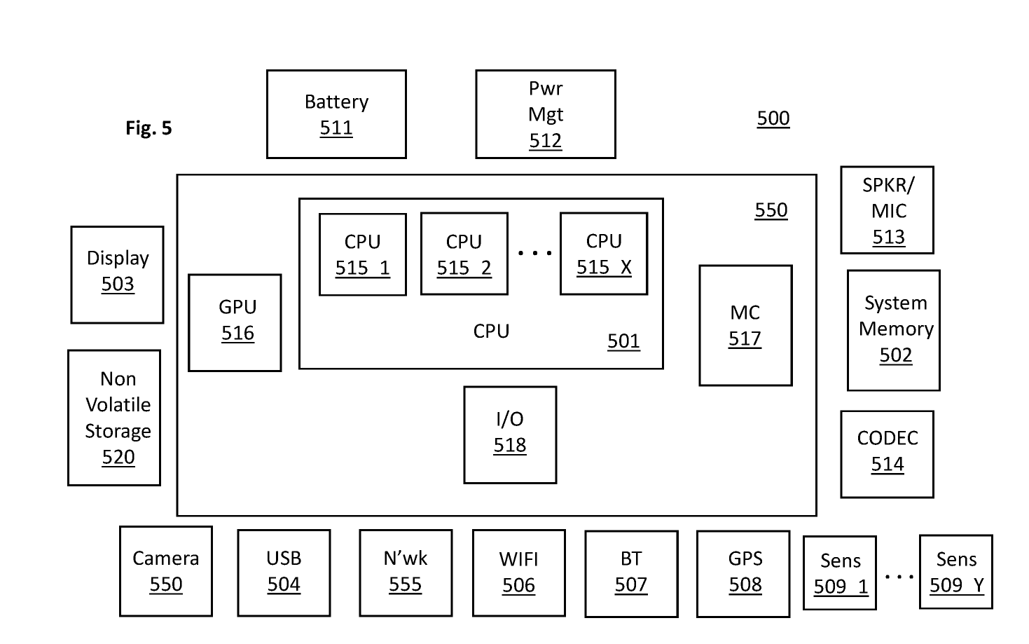

FIG. 5 shows a depiction of an exemplary computing system 500 such as a personal computing system (e.g., desktop or laptop) or a mobile or handheld computing system such as a tablet device or smartphone, or, a larger computing system such as a server computing system.

As observed in FIG. 5, the basic computing system may include a central processing unit 501 (which may include, e.g., a plurality of general purpose processing cores and a main memory controller disposed on an applications processor or multi-core processor), system memory 502, a display 503 (e.g., touchscreen, flat-panel), a local wired point-to-point link (e.g., USB) interface 504, various network I/O functions 505 (such as an Ethernet interface and/or cellular modem subsystem), a wireless local area network (e.g., WiFi) interface 506, a wireless point-to-point link (e.g., Bluetooth) interface 507 and a Global Positioning System interface 508, various sensors 509_1 through 509_N (e.g., one or more of a gyroscope, an accelerometer, a magnetometer, a temperature sensor, a pressure sensor, a humidity sensor, etc.), a camera 510, a battery 511, a power management control unit 512, a speaker and microphone 513 and an audio coder/decoder 514.

An applications processor or multi-core processor 550 may include one or more general purpose processing cores 515 within its CPU 501, one or more graphical processing units 516, a memory management function 517 (e.g., a memory controller) and an I/O control function 518. The general purpose processing cores 515 typically execute the operating system and application software of the computing system. The graphics processing units 516 typically execute graphics intensive functions to, e.g., generate graphics information that is presented on the display 503. The memory control function 517, which may be referred to as a main memory controller or system memory controller, interfaces with the system memory 502. The system memory 502 may be a multi-level system memory.

The computing system, including any kernel level and/or application software, may be able to emulate DAX mode as described at length above.

Each of the touchscreen display 503, the communication interfaces 504-507, the GPS interface 508, the sensors 509, the camera 510, and the speaker/microphone codec 513, 514 all can be viewed as various forms of I/O (input and/or output) relative to the overall computing system including, where appropriate, an integrated peripheral device as well (e.g., the camera 510). Depending on implementation, various ones of these I/O components may be integrated on the applications processor/multi-core processor 550 or may be located off the die or outside the package of the applications processor/multi-core processor 550. Non-volatile storage 520 may hold the BIOS and/or firmware of the computing system.

One or more various signal wires within the computing system, e.g., a data or address wire of a memory bus that couples the main memory controller to the system memory, may include a receiver that is implemented as decision feedback equalizer circuit that internally compensates for changes in electron mobility as described above.

Embodiments of the invention may include various processes as set forth above. The processes may be embodied in machine-executable instructions. The instructions can be used to cause a general-purpose or special-purpose processor to perform certain processes. Alternatively, these processes may be performed by specific hardware components that contain hardwired logic for performing the processes, or by any combination of programmed computer components and custom hardware components.

Elements of the present invention may also be provided as a machine-readable medium for storing the machine-executable instructions. The machine-readable medium may include, but is not limited to, floppy diskettes, optical disks, CD-ROMs, and magneto-optical disks, FLASH memory, ROMs, RAMs, EPROMs, EEPROMs, magnetic or optical cards, propagation media or other type of media/machine-readable medium suitable for storing electronic instructions. For example, the present invention may be downloaded as a computer program which may be transferred from a remote computer (e.g., a server) to a requesting computer (e.g., a client) by way of data signals embodied in a carrier wave or other propagation medium via a communication link (e.g., a modem or network connection).

What is claimed:

1. A processor, comprising:
register space to accept input parameters of a software command to move a data item out of computer system storage and into persistent system memory, the input parameters comprising an identifier of a software process that desires access to the data item in the persistent system memory and a virtual address of the data item referred to by the software process.

2. The processor of claim 1 in which the processor further comprises register space to return, in response to the command, a different virtual address to use when accessing the data item in the persistent system memory.

3. The processor of claim 2 in which memory management unit (MMU) logic circuitry of the processor is to determine the new virtual address in response to the request.

4. The processor of claim 3 in which the MMU logic circuitry is to enter a new entry in a translation look-aside buffer (TLB) of the processor for translating the new virtual address to an address of the persistent system memory useable to access the data item in the persistent system memory.

5. The processor of claim 1 in which the processor is to move the data item from a mass storage cache region of system memory to the persistent system memory, if the data item resides in the mass storage cache region.

6. The processor of claim 1 in which, if the data item resides in a mass storage cache region of the system memory, re-characterize the address where the data item resides as being associated with persistent system memory instead of the mass storage cache.

7. The processor of claim 1 in which a mass storage kernel issues the software command on behalf of the software process.

8. A computing system, comprising:
a system memory comprising a persistent system memory;
a processor coupled to the system memory, the processor comprising register space to accept input parameters of a software command to remove a data item from computer system storage and place the data item into the persistent system memory, the input parameters comprising an identifier of a software process that desires access to the data item in persistent system memory and a virtual address of the data item referred to by the software process.

9. The computing system of claim 8 in which the processor further comprises register space to return, in response to the command, a different virtual address to use when accessing the data item in the persistent system memory.

10. The computing system of claim 9 in which memory management unit (MMU) logic circuitry of the processor is to determine the new virtual address in response to the request.

11. The computing system of claim 10 in which the MMU logic circuitry is to enter a new entry in a translation look-aside buffer (TLB) of the processor for translating the new virtual address to an address of the persistent system memory useable to access the data item in the persistent system memory.

12. The processor of claim 8 in which the processor is to move the data item from a mass storage cache region of system memory to the persistent system memory, if the data item resides in the mass storage cache region.

13. The processor of claim 8 in which, if the data item resides in a mass storage cache region of the system memory, re-characterize the address where the data item resides as being associated with persistent system memory instead of the mass storage cache.

14. The processor of claim 8 in which a mass storage kernel issues the software command on behalf of the software process.

15. A machine readable storage medium containing program code that when processed by a processor of a computing system causes the computing system to perform a method, the computing system comprising persistent system memory, the method comprising:
receive a request by an application to remove a data item from storage and place the data item in the persistent system memory;
present to the processor an identifier of a software process that executes the application and a virtual address that the application uses to refer to the data item;
receive from the processor a new virtual address for the data item to be used by the application when accessing the data item in the persistent system memory; and,
forward the new virtual address to the application as a response to the request.

16. The machine readable storage medium of claim 15 where the program code is kernel level program code.

17. The machine readable storage medium of claim 16 wherein the kernel level program code is a mass storage kernel.

18. The machine readable medium of claim 15 where the application is a storage application.

19. The machine readable medium of claim 15 wherein the application is a library application that acts as a repository for handling accesses to data items in the persistent memory in a DAX emulation mode.

20. The machine readable medium of claim 19 wherein multiple applications are permitted to access the library application.
